(19) United States
(12) Patent Application Publication
(10) Pub. No.: US 2022/0022369 A1
(43) Pub. Date: Jan. 27, 2022

(54) Rake Arrangement and a Rake for Leveling Sand on a Golf Course

(71) Applicant: Talo Tuki Oy, Kempele (FI)

(72) Inventor: Jukka Tuorila, Oulu (FI)

(21) Appl. No.: 17/336,529

(22) Filed: Jun. 2, 2021

(30) Foreign Application Priority Data
Jul. 24, 2020 (FI) 20207130

(51) Int. Cl. A01D 7/04

(52) U.S. Cl. CPC A01D 7/04

(57) ABSTRACT

The present disclosure sets out a rake arrangement configured to be attached to a separate shaft part. The rake arrangement includes a sleeve part and a rake part. The rake part includes a toothed rake side and a frame side at right angles to the toothed rake side. At the end of the sleeve part there is a hinge part by means of which the rake part can be pivoted relative to the sleeve part to the storage position and the raking position. The toothed rake side has a locking arrangement with an elevated locking shape. The hinge part has indentations into which the locking shape lodges when the rake part is rotated. The indentations are positioned to lock the rake part in the storage position and the raking position.

### CROSS REFERENCE TO RELATED APPLICATIONS

This application claims the benefit of priority from Finnish Patent Application 20207130 filed 24 Jul., 2020, the content of which is herein incorporated by reference

### BACKGROUND OF THE PRESENT DISCLOSURE

The present disclosure relates to a rake arrangement for leveling sand on a golf course, the rake arrangement comprising a sleeve part and a rake part, the sleeve part having a first end and a second end of the sleeve part, the sleeve part serving to attach the rake arrangement to a separate shaft part. At the same time, an object of the present disclosure is a rake for leveling sand on a golf course, where the rake has a shaft part and a rake arrangement, which rake arrangement is attached to the end of the shaft part.

Golf courses have sand barriers, such as bunkers, that can sustain distortions or indentations in the sand surface during the game. However, the sand surface should remain flat at all times so that all players have as similar conditions as possible. For this purpose, so-called bunker rakes are used to level the sand surface. These tools are usually stored on golf courses near the sand barrier or in the sand barrier itself. This means that the rakes must be put into place when the golf course is opened and removed when the course is closed. Since the rake may not have any fixed place and it is generally located where the previous player left it. As a result, finding and collecting slows down the game not only for the players currently at the bunker but also those waiting to play through. In addition, rakes left on the course can interfere with the game and sometimes even pose an accident risk. Some players carry their own rakes, but the additional weight can be clumsy, burdensom and add more weight to the equipment they carry already.

There are products in which the carrying properties of a rake for golf course use have been improved by adding features that allow the dimensions of the rake to be changed and, in addition, to make the rake end detachable. In this case, the head of the rake can be attached to the shaft.

U.S. Pat. No. 4,854,592 discloses a rake head that can be attached to a golf club shaft. The toothed part of the rake is hinged to the end of the rake so that it can be turned parallel to the shaft of the golf club and stored inside the club. However, the construction of the rake is quite fragile and can easily break. In addition, the rake inside the club changes the balance of the club, thereby changing the structural characteristics of the club itself.

U.S. Pat. No. 6,058,691 discloses a rake arrangement that is attached to an end of a golf club shaft. The toothed part of the rake is in two parts and these parts are arranged to pivot relative to each other in the plane of the teeth of the rake so that the teeth overlap. Additionally, this structure is not very sturdy, and folding the rake arrangement is neither very simple nor quick to do.

There is a clear need for a robust and durable golf course rake that is easy to use and carry.

### SUMMARY OF THE INVENTION

Objects of the present disclosure are directed to a solution that can significantly reduce the disadvantages and drawbacks of the prior art. In particular, an object of the present disclosure is a solution that is easy to carry and use.

The present disclosure sets out a rake arrangement that is attached to a separate shaft part, which comprises a sleeve part and a rake part. The rake part comprises a toothed rake side and a frame side that is at a right angle to the toothed rake side. At the end of the sleeve part there is a hinge part by means of which the rake part can be pivoted relative to the sleeve part to the storage position and to the raking position. The toothed rake side has a locking arrangement with an elevated locking shape. The hinge part has indentations in which the locking shape engages when the rake part is rotated. The indentations are positioned to lock the rake part in the storage position and the raking position.

When reference is made to upper or lower or respective directions, a situation is described in which the rake arrangement according to the present disclosure is attached to the shaft part in its normal operating position and the direction indicated by the rake teeth tips is selected as the downward direction.

A rake arrangement for leveling sand on a golf course according to an embodiment of the present disclosure comprises a sleeve part and a rake part. The sleeve part has a first end of the sleeve part and a second end of the sleeve part, and the sleeve part serves to attach a rake arrangement to a separate shaft part. The rake part comprises a toothed rake side with a plurality of rake teeth. The rake arrangement has a storage position and a raking position.

According to a preferred embodiment of the present disclosure, when the rake part is attached to the shaft part, the rake part is configured to be movable so that the rake part can be positioned parallel to the shaft part, the rake arrangement being in the stored position, and the rake part being adjustable transverse to the shaft part.

The rake part further comprises a frame side, the frame side being an elongated plate-like construction having a first end of the frame side, a second end of the frame side, a front edge of the frame side and a rear edge of the frame side. The toothed rake side is at the front edge of the frame side, and the toothed rake side is at least partially at a right angle to the frame side. The first end of the sleeve part has a hinge part, and the sleeve part is fixed to the frame side by the hinge part so that the sleeve part can be pivoted relative to the rake part.

The rake arrangement further comprises a locking arrangement, and the locking arrangement is an elongated strip having a first end of the locking arrangement and a second end of the locking arrangement. The first end of the locking arrangement and the second end of the locking arrangement are attached to the toothed rake side so that the locking arrangement between the attachment points is at least partially detached from the surface of the toothed rake side.

The locking arrangement has a locking shape in which the locking shape has an area or areas, the distance of which from the surface of the toothed rake side is greater than the distance of the areas adjacent to the locking shape of the locking arrangement from the surface of the toothed rake side. At least a section of the surface of the hinge part is curved, and this curved surface part has a first receiving indentation and a second receiving indentation. The locking shape is configured to engage the receiving indentations when the sleeve part is rotated so that the rake part locks in place relative to the sleeve part. When the locking shape is in the first receiving indentation, the rake arrangement is in the storage position, and when the locking shape is in the second receiving indentation, the rake arrangement is in the raking position.

In an embodiment of the rake arrangement according to the present disclosure, the height of the toothed rake side, i.e. the distance from the front edge of the frame side to a rake tooth tip, is greater than the height of the rake tooth, and the locking arrangement is in the area between the front edge of the frame side and the roots of the rake tooth.

In another embodiment of the rake arrangement according to the present disclosure, the curved surface of the hinge part is a cylindrical surface, and the cylindrical surface is perpendicular to the plane of the frame side.

In a third embodiment of the rake arrangement according to the present disclosure, the curved surface of the hinge part is at least partly a spherical surface. These features facilitate the pivoting of the hinge part relative to the locking arrangement.

In a fourth embodiment of the rake arrangement according to the present disclosure, the locking shape has at least a part which is transverse to the longitudinal axis of the locking arrangement. This feature enhances lodging of the locking shape into the receiving indentation. In one embodiment, the receiving indentation is at least a partially straight groove, the plane of which is tuned by the straight part at a right angle to the plane of the frame side.

In a fifth embodiment of the rake arrangement according to the present disclosure, the locking shape is in the middle of the locking arrangement, i.e. the distances of the locking shape to the attachment points of the first end of the locking arrangement and the second end of the locking arrangement are equal.

In a sixth embodiment of the rake arrangement according to the present disclosure, the hinge part has a third receiving indentation.

In a seventh embodiment of the rake arrangement according to the present disclosure, the third receiving indentation is on the opposite side of the hinge part to the first receiving indentation, and when the locking shape is in the third receiving indentation, the rake arrangement is in the storage position, in which the locking shape is in the first position and with opposite position it is meant that the first end of the frame side and the second end of the frame side have swapped places. This feature allows the rake arrangement to be placed in different storage positions, which allows the use of curved or otherwise asymmetrical shaft parts, such as a golf club shaft.

In an eighth embodiment of the rake arrangement according to the present disclosure, the rake arrangement is configured to be in an intermediate position in addition to the storage position and the raking position, in which intermediate position the angle between the longitudinal axis of the rake part and the longitudinal axis of the shaft part deviates from a straight angle.

In a ninth embodiment of the rake arrangement according to the present disclosure, the hinge part has four or more receiving indentations. These features allow the rake teeth to be placed in a different position when raking.

In a tenth embodiment of the rake arrangement according to the present disclosure, the rake arrangement has a fastening element, and the hinge part is fastened to the frame side by the fastening element so that the hinge part is stationary with respect to the sleeve part and the sleeve part is configured so that the longitudinal axis of the fastening element is transverse to the longitudinal axis of the shaft part when the shaft part is attached to the sleeve part.

In an eleventh embodiment of the rake arrangement according to the present disclosure, the locking arrangement is configured so that the locking arrangement is located between the first end of the locking arrangement and the second end of the locking arrangement in a tensioned state, namely, one in which the locking arrangement presses against the hinge part. This feature enhances the operation of the locking arrangement.

In a twelfth embodiment of the rake arrangement according to the present disclosure, the rake part is formed in one piece, i.e. there is no connection between the frame side and the toothed rake side.

In a thirteenth embodiment of the rake arrangement according to the present disclosure, the rake part is made of anodized aluminum. This feature improves the transport and storage properties of the rake arrangement, as well as corrosion resistance. Anodizing also allows for durable staining.

A rake for leveling sand on a golf course according to an embodiment of the present disclosure comprises a shaft part and a rake arrangement, which rake arrangement is attached to the end of the shaft part. According to a preferred embodiment of the present disclosure, the rake uses the rake arrangement described in an earlier embodiment.

An advantage of the present disclosure is that it provides a sand leveling rake for golf courses that is sturdy and easy to transport. The rake arrangement according to the present disclosure is also easy and quick to manufacture.

The present disclosure also makes it possible to use a rake arrangement attached to the shaft of a golf club. In addition, it speeds up the player's game at sand obstacles.

The present disclosure also reduces the need for rakes to be brought to golf courses.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, with departing from the scope of the present disclosure.

In the following, the present disclosure is described in detail. The description refers to the accompanying drawings, in which:

FIG. 1 shows an example of a rake arrangement according to the present disclosure seen from below,

FIG. 2a shows another example of a rake arrangement according to the present disclosure in the raking position,

FIG. 2b shows the rake arrangement of FIG. 2a in the storage position,

FIG. 3a shows a third example of a rake arrangement according to the present disclosure in the raking position, viewed from the direction of the toothed rake side,

FIG. 3b shows the rake arrangement of FIG. 3a in the raking position as seen from the direction of the shaft part,

FIG. 4a shows a fourth example of a rake arrangement according to the present disclosure in the raking position, seen from the side, and

FIG. 4b shows a side view of the rake arrangement of FIG. 4a in the storage position.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”. then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

The embodiments in the following description are provided by way of example only. Though the description may refer to a certain embodiment or embodiments in several places, this does not mean that the reference would be directed towards only one described embodiment or that the described characteristic would be usable only in one described embodiment. The individual characteristics of two or more embodiments may be combined and new embodiments of the present disclosure may thus be provided.

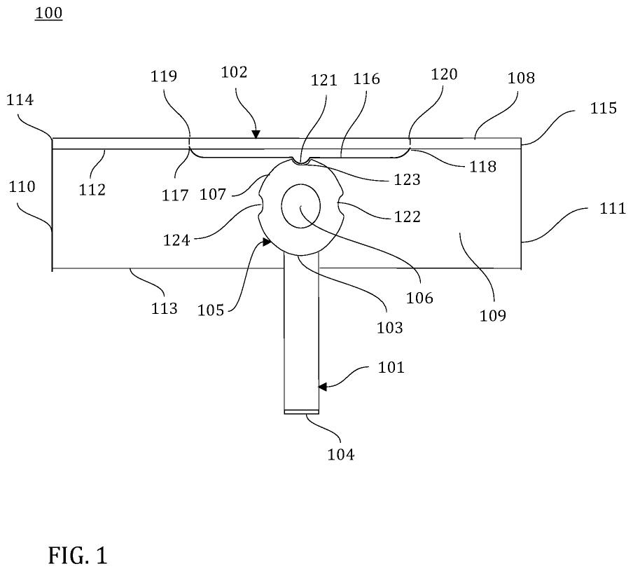

FIG. 1 depicts an embodiment of a rake arrangement 100. The rake arrangement comprises a sleeve part 101 and a rake part 102. When the rake arrangement is used, the sleeve part is attached to the shaft part (not shown in the figure).

The sleeve part 101 has a first end 103 of the sleeve part and a second end 104 of the sleeve part. In this embodiment, the sleeve part is at least partially hollow and the other end of the sleeve part is open so that the shaft part can be placed inside the sleeve part. In some embodiments, the sleeve part has a shaft part attachment arrangement for securing the shaft in place for use with the rake arrangement. In this case, the shaft part does not necessarily have to fit inside the sleeve part. In some embodiments, the shaft part is secured in place with glue or the like, with the shaft part being permanently fastened to the sleeve part. The shaft part is suitably long and shaped so that the rake arrangement can be used on and transported to golf courses to level sandy surfaces.

In some embodiments, the sleeve part is shaped so that the sleeve part can be attached to the end of the golf club shaft at either end. In some embodiments, the head part of the golf club is removed to secure the sleeve part.

The first end of the sleeve part 101 has a hinge part 105 by which the sleeve part is attached to the rake part 102. The hinge part is configured so that the rake part and the sleeve part are movable relative to each other. The hinge part has a hinge part shaft 106 and a hinge part surface 107, which surface is at least partially in the plane of the sleeve part (i.e., a plane in which the shaft part attached to the sleeve part rotates virtually about the hinge part axis). At least a part of the surface of the hinge part is curved. The axis of the hinge part is transverse to the longitudinal axis of the shaft part attached to the sleeve part (and at the same time also to the longitudinal axis of the sleeve part). In some embodiments, the curved surface of the hinge part is cylindrical or part of the cylinder, and the surface of the cylinder is parallel to the axis of the hinge part. In some embodiments, the curved surface of the hinge part is spherical. In some embodiments, the curved surface of the hinge part and the axis of the hinge part are configured to be positioned relative to each other so that when the sleeve part and the rake part are rotated relative to each other, the curved surface of the hinge part settles at different distances and at different sleeve positions with respect to some surfaces of the rake part, i.e. the axis of rotation of the curved part and the axis of rotation of the hinge part are not congruent. The rake arrangement has a fastening element with which the axis of the hinge part is implemented. The hinge part is attached to the frame side by a fastening element so that the hinge arrangement is immovable with respect to the sleeve part and the sleeve part is configured so that the longitudinal axis of the fastening element is transverse to the longitudinal axis of the shaft part when attached to the sleeve part. In some embodiments, the sleeve part is realized with an eye screw, the screw part of which secures the sleeve part to the shaft, and the eye part implements the hinge part at least partially.

When the shaft part is attached to the sleeve part 101, the rake part 102 is configured to be movable so that the rake part can be positioned parallel to the shaft part with the rake arrangement in the storage position while the rake part can be positioned transverse to the shaft part with the rake arrangement in the raking position. In the storage position, the rake arrangement 100 attached to the shaft part is easy to move and store. It can be placed, for example, in a golf bag with golf clubs. In the raking position, the rake part can be used to smooth out any unevenness in the sand surface on golf courses.

The rake part 102 comprises a toothed rake side 108 and a frame side 109. The toothed rake side has a plurality of rake teeth. The toothed rake side and the frame side may comprise plate-like structures. The frame side has a first end 110 of the frame side, a second end 111 of the frame side, a front edge 112 of the frame side and a back edge 113 of the frame side. The toothed rake side has a first end 114 of the toothed rake side and a second end 115 of the toothed rake side, as well as the top edge of the toothed rake side and the toothed edge of the toothed rake side, the last two of which are not marked in the figure. It should be noted that here, the upper edge refers to the opposite edge of the tips of the rake teeth when the direction of the rake teeth is downward. In the example depicted in FIG. 1, the rake arrangement is viewed from the direction of the rake teeth, i.e. from below.

The toothed rake side 108 is at the leading edge 112 of the frame side 109 so that the toothed rake side is at least partially at right angles to the frame side. In this case, the upper edge of the toothed rake side is attached to the front edge of the frame side. This fastening can be carried out in such a way that the toothed rake side and the frame side are separate structures that are fastened together by some known method. There are also embodiments in which the rake part 102 is in one piece, and the toothed rake side and the frame side are formed by bending or otherwise shaping the rake part. The toothed rake side has an inner surface and an outer surface. The inner surface of the toothed rake side is on the frame side, i.e. the inner surface is towards the hinge part 105 and the sleeve part 101. The outer surface of the toothed rake side is on the opposite side of the toothed rake side from the inner surface.

The rake arrangement 100 further comprises a locking arrangement 116. The locking arrangement is an elongated thin strip-like body, i.e. its length is greater than its height. The locking arrangement has a first end 117 of the locking arrangement and a second end 118 of the locking arrangement, as well as a top side and a bottom side. The first end of the locking arrangement and the second end of the locking arrangement are attached to the inner surface of the toothed rake side so that the locking arrangement between the attachment points is at least partially off the toothed rake side surface and the underside of the locking arrangement faces the frame side 109.

The attachment points of the first end of the locking arrangement and the second end of the locking arrangement are selected so that the locking arrangement is arranged between the hinge part 105 and the toothed rake side. The distance between the attachment points of the locking arrangement is shorter than the length of the locking arrangement, i.e. the distance between the first end 117 of the locking arrangement and the second end 118 of the locking arrangement. In the embodiment of FIG. 1, the toothed rake side 108 has a first slot 119 and a second slot 120. The attachment of the locking arrangement is accomplished by inserting the first end of the locking arrangement into the first slot and the second end of the locking arrangement into the second slot. Of course, the fastening of the locking arrangement can be implemented in different ways in different embodiments. In one embodiment, the locking arrangement is configured to be between the first end of the locking arrangement and the second end of the locking arrangement in a tensioned state in which the locking arrangement presses against the hinge part. Alternatively, the hinge part is arranged so that the hinge part presses against the locking arrangement and in particular the center of the locking arrangement towards the toothed rake side. There are also embodiments in which the tensioned state of the locking arrangement is implemented in both of these ways at the same time.

The locking arrangement 116 has a locking shape 121. The locking shape has an area or areas whose distance from the inner surface of the rake prong side is greater than the distance of the areas adjacent to the lock design of the locking arrangement from the inner surface of the toothed rake side. In the embodiment of FIG. 1, the locking design is implemented with a protrusion transverse to the longitudinal axis of the locking arrangement, which extends from the top side to the bottom side of the locking arrangement. The cross section of the protrusion is curved in this embodiment. The shape of the locking arrangement, viewed from the direction of the upper side of the locking arrangement, as shown in FIG. 1, resembles a round bracket. In this embodiment, the locking shape is in the center of the locking arrangement, i.e., the distance of the locking shape to the attachment points of the first end of the locking arrangement and the second end of the locking arrangement is equal.

In the embodiment shown in FIG. 1, the curved surface part 107 of the hinge part 105 has three receiving indentations: a first receiving indentation 122, a second receiving indentation 123, and a third receiving indentation 124. The receiving indentations are shaped so that the locking shape 121 settles in the receiving indentation and locks the sleeve part 101 and the rake part 102 are immobile relative to each other. This locked state can be removed by turning the sleeve part with sufficient force, so that the locking arrangement 116 in the tensioned state flexes and the hinge part 105 can turn, making the locking shape leave the receiving indentation. In this rotation of the sleeve part, the shaft 106 of the hinge part acts as a pivot axis. The receiving indentations of the embodiment shown in FIG. 1 are positioned so that when the locking shape is in the second receiving indentation, the rake arrangement is in the raking position, and when the locking shape is in the first receiving indentation, the rake arrangement is in the storage position. The third receiving indentation is positioned so that when the locking shape is in the third receiving indentation, the rake arrangement is in the storage position, but the position of the rake arrangement is opposite to that of the storage position in which the rake arrangement is when the lock design is in the first receiving indentation. The first receiving indentation and the third receiving indentation are on opposite sides of the hinge part 105. In some embodiments, there are two receiving indentations and they place the rake arrangement 100 in the storage position and the raking position. In some embodiments, in addition to the storage position and the raking position, the rake arrangement is configured to be in an intermediate position, in which the angle between the longitudinal axis of the rake part and the longitudinal axis of the shaft part deviates from the straight angle. The intermediate position is realized in some embodiments by placing the third receiving indentation at a location other than opposite to the first or second receiving depression. In some embodiments, the intermediate position or positions are implemented by increasing the number of receiving indentations.

The receiving indentations are such that the locking shape 121 fits into the receiving indentation so that the walls of the receiving indentations support the locking shape on both sides. In some embodiments, the receiving indentations are at least partially straight grooves, the plane of which may be a straight part which is at least partly straight. The plane of the straight part may be at right angles to the plane of the frame side. In this case, the locking shape is also at right angles to the plane of the frame side.

The locking shape does not have to completely fit the receiving indentation. In some embodiments, the walls of some receiving indentations are more gradual than the walls of other receiving indentations, or the depth of the receiving indentations is less than that of other receiving indentations. Thus, it is possible to provide a rake arrangement 100 in which some locking positions can be released with less force than others. Such is the case, for example, with an embodiment with receiving indentations that lock the rake arrangement in intermediate positions, and these receiving indentations are more gradual or lower in cross-section than receiving indentations with which the rake arrangement is locked in the storage position or raking position.

In some embodiments, at least the rake part 102 is anodized aluminum. Aluminum is light and durable, and the anodizing forms a matte layer on the surface of the aluminum. These features improve the durability and usability of the rake part. In one embodiment, the thickness of the aluminum sheet used in manufacturing the rake section is two millimeters. In some embodiments, the thickness of the aluminum sheet used ranges from 1.5 to 3 millimeters.

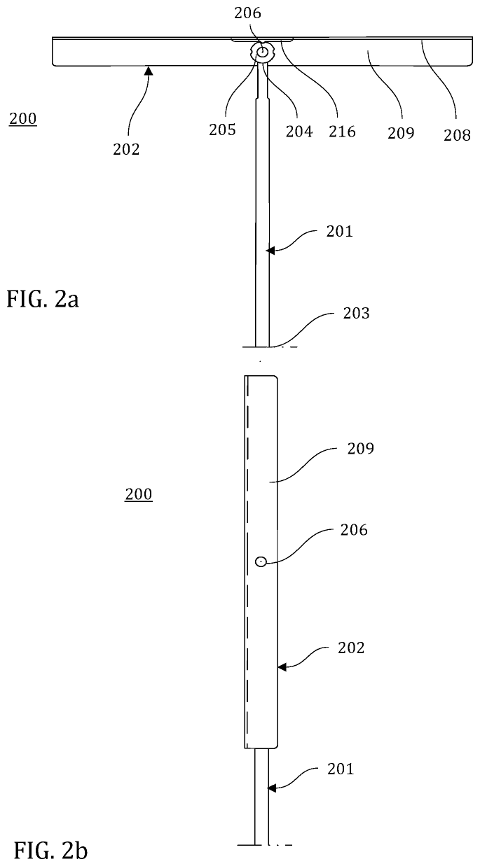

Another embodiment of the rake arrangement 200 is shown in FIG. 2a in a raking position and in FIG. 2b in a storage position.

The rake arrangement 200 has a sleeve part 201 and a rake part 202. The rake part has a frame side 209 and a toothed rake side 208 with a plurality of rake teeth. The sleeve part has a first end 203 of the sleeve part and a second end 204 of the sleeve part. The sleeve part is attached to the shaft part at one end of the sleeve part, and the first end of the sleeve part has a hinge part 205. The hinge part has a shaft 206 of the hinge part, which is a fastening element with which the sleeve part is fixed to the frame side so that the sleeve part is pivotable such that the axis of the hinge part is an axis of rotation. A locking arrangement 216 is attached to the toothed rake side between the hinge part and the toothed rake side. The locking arrangement has a locking shape and the hinge part has at least two receiving indentations in which the locking shape settles to lock the sleeve part in different positions relative to the rake part when the sleeve part is rotated.

In FIG. 2a, the rake arrangement 200 is viewed from the direction of the rake teeth. The rake part is locked in a transverse position relative to the sleeve part 201, i.e. in the raking position. In FIG. 2b, the rake arrangement is viewed from the opposite direction, with the hinge part 205 being on the opposite side of the frame side 209 from that shown in FIG. 2a. The axle 206 of the hinge part, i.e. the fastening element, passes through the frame side and fastens the hinge part and, at the same time, the sleeve part 201 to the rake part 202. The rake part is locked in a longitudinal position relative to the sleeve part, i.e. in the storage position. It should be noted that the sleeve part and the shaft part attached to it cannot be rotated over the toothed rake side 208 and at the same time over the rake teeth, but the trajectory of the sleeve part is about 180 degrees. In FIG. 2b, the sleeve part is parallel to the toothed rake side.

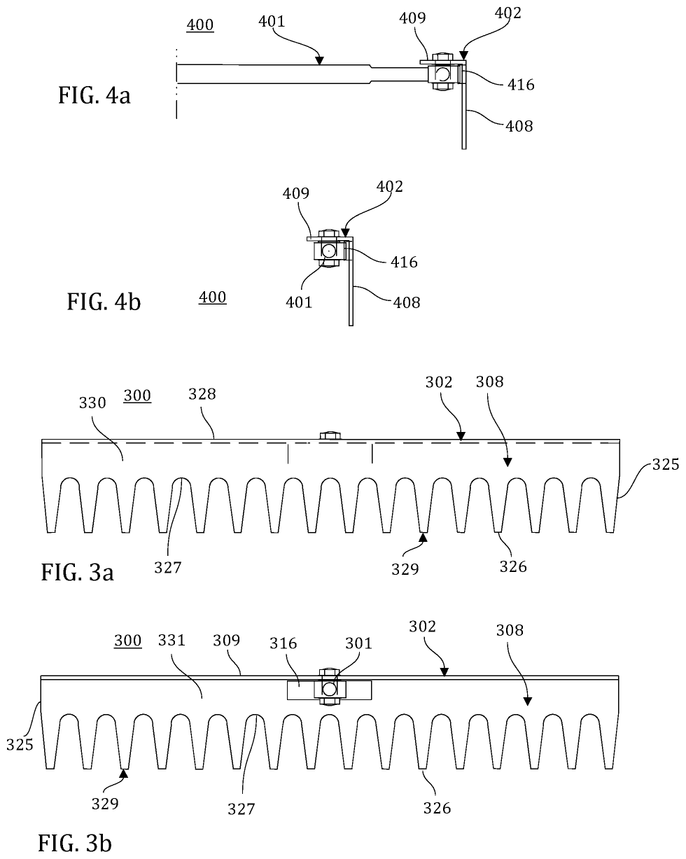

A third embodiment of the rake arrangement 300 is shown in FIG. 3a in the raking position from the direction of the toothed rake side and in FIG. 3b in the raking position from the direction of the shaft part and at the same time, from the sleeve part.

The rake arrangement 300 has a sleeve part 301 and a rake part 302. The rake part has a frame side 309 and a toothed rake side 308 with a plurality of rake teeth 325. The toothed rake side is attached to the edge of the frame side so that the angle between the toothed rake side and the frame side is a right angle or close to it. A rake tooth has a rake tooth tip 326 and a rake tooth root 327. The toothed rake side has an upper edge 328 of the toothed rake side and a tooth edge 329 of the toothed rake side. The toothed rake side has an outer surface 330 and an inner surface 331. The sleeve part is attached to the frame side with a hinge part 305. There are receiving indentations on the surface of the hinge part. The rake part has a locking arrangement 316 on the inner surface of the toothed rake side so that the locking arrangement is between the hinge part and the toothed rake side.

In FIG. 3a, the outer surface 330 is visible from the toothed rake side 308. The length of the rake teeth 325 is the distance between the rake tooth tip 326 and the rake tooth root 327. In this embodiment, the root or root plane of the rake tooth is considered to be the point within the area between the rake teeth that is closest to the top of the toothed rake side. The height of the toothed rake side is the direct distance from the top edge 328 of the toothed rake side to the tooth edge 329 of the toothed rake side at the farthest point, i.e. the tip of the rake tooth. The height of the toothed rake side is greater than the length of a rake tooth, i.e. there is an area between the roots of the rake teeth and the top edge of the toothed rake side where the rake tooth side is uniform.

In FIG. 3b, the inner surface 331 of the toothed rake side 308 is shown. The locking arrangement 316 is on the inner surface in said uniform area. This simplifies the mounting of the locking arrangement and provides more options than attaching it to the rake teeth. In addition, the locking arrangement does not interfere with raking.

A fourth embodiment of the rake arrangement 400 is shown in FIG. 4a in the raking position, as seen from the side, i.e. from the direction of the end of the rake arrangement (the other end of the frame side) and in FIG. 4b in the storage position from the same direction.

The rake arrangement 400 has a sleeve part 401 and a rake part 402. The rake part has a frame side 409 and a toothed rake side 408. The sides are elongated sheet structures with long edges and short edges between the long edges. Frame sides are joined at their long sides so that the cross-section of the rake arrangement is L-shaped and the angle between the sides is 90 degrees or close to it. At least the edges at which the sides are attached to each other are of equal length. The sleeve part pivots relative to the rake part by means of a hinge part fixed to the frame side. The sleeve part can be locked in different positions, which are at least the raking position (FIG. 4a) and the storage position (FIG. 4b), by a locking arrangement 416 between the toothed rake side and the hinge part. In this embodiment, the locking arrangement may be made of a metal strip and is attached to the toothed rake side so that the locking arrangement is in a tensioned state. The hinge part is configured to press the locking arrangement against the toothed rake side. The hinge part has receiving indentations and the locking arrangement has a locking shape that rises higher than the other parts of the locking arrangement relative to the surface of the toothed rake side. The receiving indentations and the locking shape are configured to match. When the hinge part pivots as the sleeve part rotates, the locking shape settles in the receiving indentation and locks the rake part and the sleeve part together so that the locking shape rises from the receiving indentation only when sufficient force is applied to rotate the sleeve part and, at the same time, the hinge part. The walls of the receiving indentations are such that the locking shape can slide over them when the sleeve part is rotated, i.e. the rake part and the sleeve part are moved relative to each other. By varying the shape of the locking shape and the placement of the hinge part on the frame side, the tightness of the lock can be adjusted.

In some embodiments, moving the rake part out of the raking position requires more force than moving the rake part out of the storage position. In this case, the possibility of the rake part being inadvertently moved away from the raking position during raking is reduced.

Some advantageous embodiments of the device according to the present disclosure have been described above. The present disclosure is however not limited to the embodiments described above, but the inventive idea can be applied in numerous ways within the scope of the claims.

1. A rake arrangement for leveling sand on a golf course, the rake arrangement comprising:
a sleeve part comprising a first end and an other end, and configured for attaching the rake arrangement to a separate shaft part,
a rake part comprising a toothed rake side having a plurality of rake teeth, the rake arrangement is configured to have a storage position and a raking position, and
wherein when the rake part is attached to the shaft part, the rake part is configured to be movable so as to enable the rake part to be positioned parallel to the shaft part, the rake arrangement being in the storage position, and
wherein the rake part is configured to be adjustable transversely to the shaft part, the rake arrangement being in the raking position, further comprising a frame side, the frame side being an elongated sheet-like structure having a first end of the frame side, run the second end, the front edge of the frame side and the rear edge of the frame side,
wherein the toothed rake side is arranged at the front edge of the frame side such that the toothed rake side is at least partially at right angles to the frame side,
wherein the sleeve part comprises a hinge part and is hinged to the frame side so that the sleeve part is pivotable relative to the rake part,
wherein the rake arrangement further comprises a locking arrangement comprising an elongated strip having a first end and a second end such that the first end of the locking arrangement and the second end of the locking arrangement are attached to the toothed rake side so that the locking arrangement between the attachment points is at least partially detached from the toothed rake side surface, and the locking arrangement has a locking shape or areas with a distance from the toothed rake side surface greater than the distance of the areas adjacent to the locking shape of the locking arrangement from the toothed rake side surface, and
wherein at least a part of the hinge surface curved, such that a curved surface part of the hinge surface comprises a first receiving indentation and a second receiving indentation, and
wherein the locking shape is configured to settle into the receiving indentations when the sleeve part is rotated so that the rake part locks in place relative to the sleeve part, and
wherein when the locking shape is in the first receiving indentation, the rake arrangement is in the storage position, and when the locking shape is in the second receiving indentation, the rake arrangement is in the raking position.

2. The rake arrangement according to claim 1, wherein a height of the toothed rake side defining a distance from the front edge of the frame side to the rake tooth tip, is greater than a height of the rake tooth, and the locking arrangement is arranged in an area between a leading edge of the frame side and roots of the rake teeth.

3. The rake arrangement according to claim 1, wherein the curved surface of the hinge part comprises a cylindrical surface arranged perpendicular to a plane of the frame side.

4. The rake arrangement according to claim 1, wherein the curved surface of the hinge part comprises at least partly a spherical surface.

5. The rake arrangement according to claim 1, wherein the locking shape comprises at least a part that is transverse to the longitudinal axis of the locking arrangement.

6. The rale arrangement according to claim 1, wherein the locking shape is arranged at a center of the locking arrangement such that distances of the locking shape from the first end to the attachment points of the other end of the locking arrangement are equal.

7. The rake arrangement according to claim 1, wherein the hinge part comprises a third receiving indentation.

8. The rake arrangement according to claim 7, wherein:
the third receiving indentation is arranged on an opposite side of the hinge part to the first receiving indentation, and
when the locking shape is in the third receiving indentation, the rake arrangement is in a storage position in which the frame side is in the opposite position to the storage position in which the locking shape is in the first position, and the opposite position means that the first end and frame side the other end have switched places.

9. The rake arrangement according to claim 7, wherein the rake arrangement is configured to be in an intermediate position in addition to the storage position and the raking position, in which an angle between a longitudinal axis of the rake part and a longitudinal axis of the shaft part deviates from a right angle.

10. The rake arrangement according to claim 7, wherein the hinge part comprises four or more receiving indentations.

11. The rake arrangement according to claim 1, wherein the rake arrangement comprises a fastening element and the hinge part is configured to be fastened to the frame side by the fastening element so that the hinge part is stationary with respect to the sleeve part and the sleeve part is configured so that the longitudinal axis of the fastening element is transverse to the longitudinal axis of the shaft part when the shaft part is attached to the sleeve part.

12. The rake arrangement according to claim 1, wherein the locking arrangement is configured so that the locking arrangement is arranged between the first end of the locking arrangement and the second end of the locking arrangement in a tensioned state in which the locking arrangement presses against the hinge part.

13. The rake arrangement according to claim 1, wherein the rake part is formed in one piece, such that there is no connection between the frame side and the toothed rake side.

14. The rake arrangement according to claim 1, wherein the rake part is made of anodised aluminum.

15. (canceled)
